(19) United States
(12) Patent Application Publication
(10) Pub. No.: US 2026/0311723 A1
(43) Pub. Date: Oct. 8, 2026

(54) NON-ALIGNED EXCHANGE-DE-COUPLED DUAL-LAYER SYSTEM FOR INCREASED AREAL-DENSITY

(71) Applicant: Seagate Technology LLC, Fremont, CA (US)

(72) Inventors: Aneesh Venugopal, Edina, MN (US); Peter Jeremy Czoschke, Bloomington, MN (US); Thomas Young Chang, Menlo Park, CA (US)

(21) Appl. No.: 19/169,177

(22) Filed: Apr. 3, 2025

(51) Int. Cl. G11B 5/66; G11B 5/65

(52) U.S. Cl. CPC G11B 5/676; G11B 5/653

(57) ABSTRACT

HAMR magnetic media are disclosed. The HAMR magnetic media comprises two layers of magnetic recording media separated by an exchange break layer. The grain structures of the first and second magnetic recording media are not aligned.

### BACKGROUND

Data storage devices such as hard-disk drives (HDDs) using heat-assisted magnetic recording (HAMR) technology typically utilize a laser on a read/write head to heat a small spot on a magnetic recording disk to permit relatively high areal density capability (ADC) with relatively high anisotropy media. Heating the magnetic recording disk temporarily reduces the coercivity of the magnetic media, which enables the read/write head to change the magnetization direction of a bit and thus store information to the magnetic media. There is a continuing desire to increase ADC even further, which can be technically challenging.

### SUMMARY

Aspects of the invention described herein are directed to a dual layer magnetic recording media having separate, non-aligned grain structures in each layer.

In one aspect, a magnetic media comprises a first granular recording layer having a grain structure, a second granular recording layer having a grain structure and a continuous break layer separating the first and second recording layers, wherein the grain structures of the first and second recording layers are not aligned.

In another aspect, the first and second recording layers of the magnetic media have substantially the same Curie temperature.

In another aspect, the continuous break layer is a dielectric material.

In another aspect, the continuous break layer comprises MgO or Ru.

In another aspect, first and second recording layers comprise FePt.

In another aspect, the magnetic media of this disclosure further comprises a cap layer.

In another aspect, a data storage device comprises a housing, one or more electronic components disposed within the housing and at least one magnetic recording disk comprising a magnetic media of this disclosure.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 illustrates a data storage device including a read/write head assembly for writing data on a magnetic storage medium;

FIG. 2 illustrates an example magnetic media that facilitate writes of zero-state polarity to localized regions on a magnetic media in a HAMR device; and

FIGS. 3 and 4 show the plotted data from Table 1.

### DETAILED DESCRIPTION

This disclosure describes a two layered recording media with each recording layer having a different grain structure and separated by a continuous break layer. The different grain structures of the recording layers is created by using different grain seeding for the first and second recording layers. Due to the random nature of the differing grain boundary locations, regions of net zero magnetization (top and bottom overlapping regions of opposite magnetization) occurs naturally. Each recording layer has substantially the same Curie temperature so to retain similar thermal characteristics. This configuration increases areal density capability (ADC) and minimizes track width differences between the first and second recording layers, improving track pitch capability. Additionally, a continuous break layer, for example MgO, has no diffusion issues and allows for the growth of a second granular recording layer. A non-aligned dual recording layer configuration is significantly easier to manufacture as compared to other configurations, for example, an aligned dual recording layer configuration that relies on a granular break layer.

### Definitions

“Substantially equal Curie Temperatures” (Tc) means Tc's within a maximum of a 2% temperature difference.

The present disclosure relates to an improved two layer magnetic recording stack, for use with data storage devices such hard disk drives (HDDs). Various types of magnetic recording mechanisms are used in hard disk drives. While the conventional magnetic recording (CMR) scheme allows for random writes, the write is more restricted in the shingled magnetic recording (SMR) scheme. A heat-assisted magnetic recording mechanism may be used in conjunction with shingled magnetic recording (SMR) technique, to achieve higher areal storage density. A hard disk drive that includes magnetic recording layers according to the present disclosure can include any of the HAMR types of recording mechanisms.

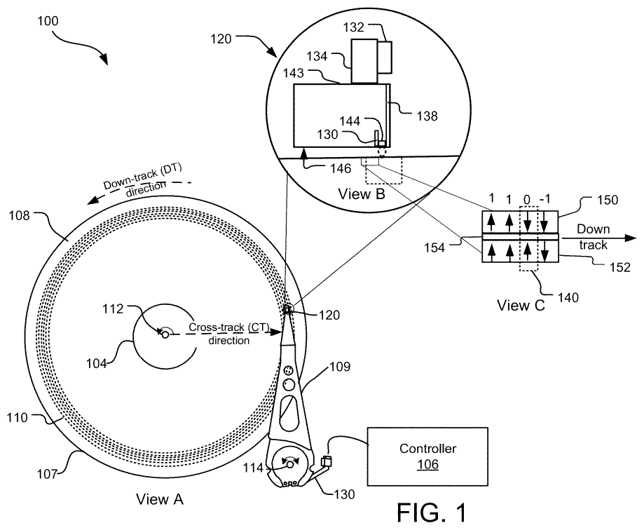

Before discussing magnetic granular recording layers according to the present disclosure, a non-limiting example of a data storage device 100 that may include one or more magnetic stacks will be described with respect to FIG. 1.

FIG. 1 illustrates a data storage device 100 including a read/write head assembly 120 for writing data on a magnetic storage medium 108. The magnetic storage medium 108 is a magnetic storage disc on which data bits can be recorded and read using read and write elements on a read/write head assembly 120. As illustrated in View A, the magnetic medium 108 includes an inner diameter 104 and an outer diameter 107 between which are a number of concentric data tracks (e.g., a data track 110) along which data may be written to and read from at respective bit locations as the magnetic medium 108 rotates about a spindle center or a disc axis of rotation 112.

The read/write head assembly 120 is mounted on an actuator assembly 109 at an end distal to an actuator axis of rotation 114. The read/write head assembly 120 flies in close proximity above the surface of the magnetic medium 108 during disc rotation. The actuator assembly 109 rotates during a seek operation about the actuator axis of rotation 112, which positions the read/head assembly 120 over a target data track for read and write operations.

The read/write head assembly 120 is a heat-assisted magnetic recording (HAMR) head that includes a heat source applied to a bit location on the magnetic medium 108 during recording. By temporarily heating the storage medium 108 during the recording process, the magnetic coercivity of the magnetic grains in the storage medium 108 can be selectively lowered below an applied magnetic write field in a tightly focused area of the magnetic medium 108 that substantially corresponds to an individual data bit. The heated region is then encoded with the recorded data bit based on the polarity of the applied magnetic write field. After cooling, the magnetic coercivity substantially returns to its pre-heating level, thereby stabilizing the magnetization for that data bit. After being recorded, such data bits can be read using a magneto-resistive read head.

Referring to View B, the read/write head assembly 120 includes, among other features, a heat source 132 (e.g., a laser) coupled to a submount assembly 134. Light from the heat source 132 is directed into a waveguide 138 mounted to a slider 143. Light exiting the waveguide is focused, via a Near Field Transducer (NFT) 144, and applied to a bit location on the magnetic medium 108 while the bit location is subjected to a magnetic field generated by the write element 130. As an air-bearing surface 146 of the read/write head assembly 120 “flies” across the surface of the magnetic medium 108, the write element 130 selectively magnetizes the underlying magnetic grains of the magnetic medium 108.

A controller 106 generates control signals to control power to the write element 130 and to control the polarity of the magnetic field generated by the write element 130. In one implementation, the controller 106 controls the write element 130 to encode data bits of two logical states on a single pass of the write element 130 over a data track on the magnetic media. That is, the write element encodes data bits with positive magnetic polarity (1), data bits with negative magnetic polarity (−1). Regions with approximately zero net magnetization, hereby referred to as the zero-insertion regions, get inserted between consequent bits of opposite polarity. Although these regions do not store any information bit, the zero insertion helps to improve the signal to noise ratio (SNR) that is obtained from the system. Referring to View C, the magnetic medium 108 is shown to include at least two magnetic recording layers, an second recording layer 150 and a first recording layer 152, which both include magnetic material, such as FePt or an alloy thereof. A continuous break layer 154 separates the second recording layer 150 and the first recording layer 152.

In one implementation, the second recording layer 150 and the first recording layer 152 include granular magnetic material (e.g., material having magnetic grains separated from one another by non-magnetic material). During a manufacturing process, the individual grains in the second recording layer 150 are grown independently of the first recording layer 152. The magnetic grains in the second layer are not aligned with grains in the first layer. The magnetic grains in both layers may be substantially the same in size (e.g., within +/−10% of one another). Sizes of the magnetic grains in each recording layer range from about 4 nm to about 8 nm.

View C illustrates four data bits that have been written in sequence during a single pass of the read/write head assembly 120 over the media. Each data bit is represented by a pair of vertically stacked arrows that further represents multiple magnetic grains in a tightly focused area. From left to right, View C shows a sequence of data bits in the corresponding states 1, 1, 0, and −1. The ‘1’ state data bits each have a positive polarity—that is, substantially all grains in the second recording layer 150 and in the first recording layer 152 of the data bit are fixed to have a positive polarity. The ‘-1’ state data bits each have a negative polarity, meaning that substantially all grains in the second recording layer 150 and the first recording layer 152 are fixed to have a negative polarity. The ‘0’ state (e.g., in a region 140) has a polarity of substantially zero due to the fact that each grain in the second recording layer 150 is fixed to have polarity that is opposite that of a corresponding (stacked) magnetic grain in the first recording layer 152. The ‘+1’ and ‘−1’ bits are used for information storage and the naturally inserted ‘0’ bits are used to improve the SNR of the recording system, as mentioned earlier. In View C, the illustrated ‘0’ state data bit is shown to have a negative polarity in the second recording layer 150 and a positive polarity in the first recording layer 152. While it may be the case that all grains in the second layer of the data bit have negative polarity and all grains in the first layer of the data bit have positive polarity, it is to be appreciated that this is just one example of magnetic grain orientation that results in substantially zero net polarity within the region 140. Other examples are discussed herein.

The term “substantially zero polarity” is used herein to refer to regions where the individual grains have true substantially net zero polarity (e.g., each grain has an second layer portion with a polarity opposite in magnitude and sign of that of a corresponding first layer portion). However, “substantially zero polarity” is also intended to encompass the scenario where the magnetic and/or physical characteristics of the two recording layers are tuned such that the read element on the read/write head assembly 120 detects substantially zero polarity in a given region when the true net polarity of the region is somewhat greater or less than substantially zero. Since the second recording layer 150 is in closer proximity to the read/write head assembly 120 than the first recording layer 152, the first recording layer 152 may contribute less to the readback signal than the second recording layer 150. Consequently, there exist real-world scenarios where the net polarity of a region could actually be zero but where the read element nevertheless detects a non-zero signal. To adjust for this effect, some implementations of the disclosed technology may provide for tuning of the first recording layer 152 to have an Mrt (magnetic saturation times the layer thickness) that is greater than the Mrt of the second recording layer 150 to ensure that the read element detects substantially zero net polarity in the zero state regions. In these cases, the “zero state” regions on the media may have a true polarity biased toward that of the first recording layer 152 (due to its greater Mrt), but an effective polarity that is detected by the read element as being zero or substantially zero. This tuning of Mrt may be performed with respect to any of the implementations disclosed herein.

According to the various implementations disclosed herein, the three states illustrated in View C may all be written—in entirety—during a single pass of the read/write head above the rotating magnetic medium 108. Techniques for accomplishing this are discussed with respect to the following figures.

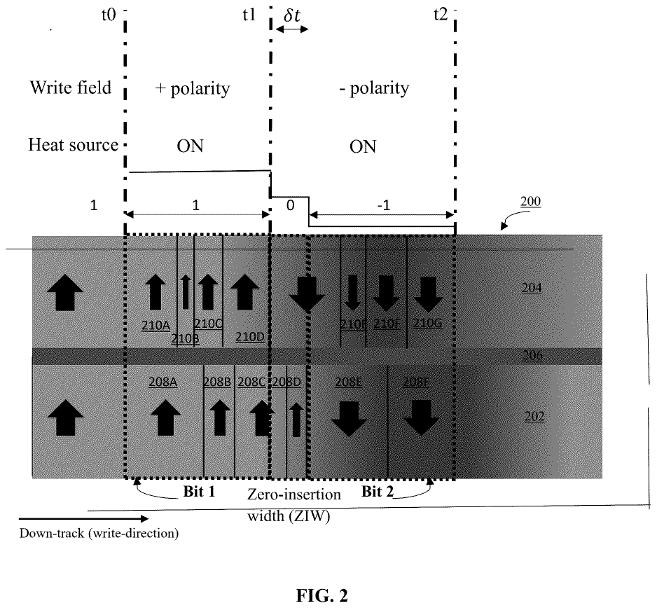

FIG. 2 illustrates an example of a magnetic stack 200 that may represent an example of a magnetic recording disk 108 used in a heat assisted magnetic recording (HAMR) hard disk drive (HDD). As shown in FIG. 2, magnetic stack 200 includes at least a first granular recording layer 202, a second granular recording layer 204, and a continuous break layer 206 in between the first and second recording layers. A recording disk may have two or more magnetic layers that are each set separated by a continuous break layer. For example, the disk may have three magnetic layers where a first break layer lies between a first magnetic layer and a second magnetic layer, and a second break layer lies between the second magnetic layer and a third magnetic layer.

In FIG. 2, timesteps t0 and t1 illustrate states of a heat source and of a write field applied by a write element that are effective to write corresponding states 1, 0, and −1 (from the left to right) on the magnetic media 200. During time t0 to t1, the heat source is in the “ON” state and the applied write field has a positive polarity. As the magnetic media 200 cools in the presence of the applied positive-polarity magnetic field, the magnetization in the second granular recording layer 204 and the first granular recording layer 202 align to the same direction as the applied field as it cools and maintains the positive polarity due to the high anisotropy of the FePt grains within the individual layers.

At time t1, the heat source is in the “ON” state and the applied write field is switched to a negative polarity. At the bit-edges during such write-field transitions, for a short time interval, δt, the asymmetry between the top and bottom layers in the presence of thermal fluctuations can lead to the grains in the top and bottom layer switching in opposite directions. The width of such naturally inserted zero states is referred to as the zero-insertion-width. As cooling continues, the opposing polarity within these grains is frozen due to the high anisotropy of the FePt grains. This effect drives the net magnetization of the individual grains within the zero-insertion-width close to zero.

During time t1+δt to t2, the heat source is in the “ON” state and the applied write field is switched to a negative polarity. As the magnetic media 200 cools in the presence of the applied negative-polarity magnetic field, the magnetization in the second granular recording layer 204 and the first granular recording layer 202 align to the same direction as the applied field as it cools and maintains the negative polarity due to the high anisotropy of the FePt grains within the individual layers. The first and second granular recording layers have substantially the same Curie Temperature (Tc) and the grains in each recording layer are not aligned. As shown in FIG. 2, first granular recording layer 202 has top grains 208 A-F and second granular recording layer 204 has bottom grains 210 A-G and the top and bottom grains are not aligned. For example, the border of grain 208A shown by a solid line does not align with grain 210A.

In one implementation, the continuous break layer comprises a dielectric material such as magnesium oxide. In one implementation, the recording layers comprise FePt or an alloy thereof and may also contain one or more segregants such as. B2O3, WO3, MoO3, Zr,O2, ZnO, CuO, Cr2N, Si3N4, VN, AlN, NbN, TiN, BN, TaN, HfN, C or h-BN.

In some embodiments, a granular recording layer according to the present disclosure has a thickness of 1 nanometer or greater, 2 nanometers or greater, 3 nanometers or greater, 4 nanometers or greater, 5 nanometers or greater, 10 nanometers or greater, or even 15 nanometers or greater. In some embodiments, a granular recording layer according to the present disclosure has a thickness of 10 nanometers or less, or even 5 nanometers or less. In some embodiments, a granular recording layer has a thickness of from 1 to 30 nanometers, or even from 5 to 25 nanometers. Granular recording layers of the implementation are produced by sputtering methods.

The continuous break layer of this disclosure is not thermally insulating, that is, is not a thermal barrier. An example of a continuous break layer of this disclosure is a break layer made from MgO. Another useful material for the continuous break layer is ruthenium (Ru). As mentioned earlier, the break layer is expected to break the exchange coupling between the top and bottom layers. The continuous break layer is deposited using sputtering. In some embodiments, a continuous break layer of the present disclosure has a thickness of from 1 to 20 nanometers.

The magnetic recording media of this disclosure may also further comprise a cap layer. An example of a cap layer of this disclosure is a cap layer having a high Tc, that is a Tc about ~100 K-200 K higher than the Tc of the storage layers (the upper and lower Tc being typically within 1-2% and a maximum of 2% within each other), and low anisotropy field (Hk) (or equivalently low coercivity, (Hc)). A cap layer having a high Tc can improve the performance by improving the switching probability at the high write temperatures used. A cap layer having a high Tc provides a finite magnetic-moment even when the granular recording layers below the cap layer are heated to or above the Tc of the granular recording layers. This provides an effective magnetic field in addition to the externally applied magnetic field used to record the bits. The switching-assist of the cap layer improves the signal to noise ratio (SNR) of the non-aligned dual layer recording media design of this disclosure.

The non-aligned recording layers of the present implementation are made by sputtering the continuous break layer onto a layer of granular recording layer, for example, the bottom granular recording layer by sputtering. The continuous break layer is sputtered onto the bottom granular recording layer at a thickness which breaks any magnetic influence from the bottom granular layer. When sputtered, the top granular layer will nucleate randomly, forming grains in each granular layer that are un-aligned.

### Examples

“BPIC” means Bits per Inch Capability.
“TPIC” means Tracks per Inch Capability.
“ADC” means Areal Density Capacity.

ADC Measurement using Micromagnetic Simulations. The recording media had a grain size of 6.5 nm (17%) and a magnetic stack thickness of 16 nm, each recording layer had a thickness of 8 nm. Uniaxial Anisotropy: Ku=2.5e7 emu/cc; Tc=694K; and no extrinsic Tc sigma added. An 18k/nm thermal profile was used. Writer parameters were: 10kOe at 0 degrees. Reader parameters were: MT10/esnr/PW50=28 nm/25 dB/18 nm; Channel Pber: −2.25 (on-track); −1.45 (triple-track). Results of the simulation are shown in Table 1.

TABLE 1

| | | Peak | | | |
|---|---|---|---|---|---|
| Grain Size | | Temperature | | | |
| (Distribution) | Design | (K) | BPIC | TPIC | ADC |
| 6.5 nm | Baseline | 772 | 2694 | 1385 | 3.73 |
| (17%) | (Single | | | | |
| | Layer) | | | | |
| 6.5 nm | Non-Aligned | 741 | 2691 | 1459 | 3.93 |
| (17%) | Grains (Dual | | | | |
| | Layer) | | | | |
| 7 nm | Baseline | 824 | 2927 | 1248 | 3.65 |
| (14%) | (Single | | | | |
| | Layer) | | | | |
| 7 nm | Non-Aligned | 785 | 2823 | 1337 | 3.77 |
| (14%) | Grains (Dual | | | | |
| | Layer) | | | | |

The data in Table 1 show an ADC improvement of about 8% in the non-aligned dual layer configuration compared to the single layer configuration when using 65 nm grains (17% distribution) and a reduction in the peak operating temperature for both 6.5 nm and 7 nm grains.

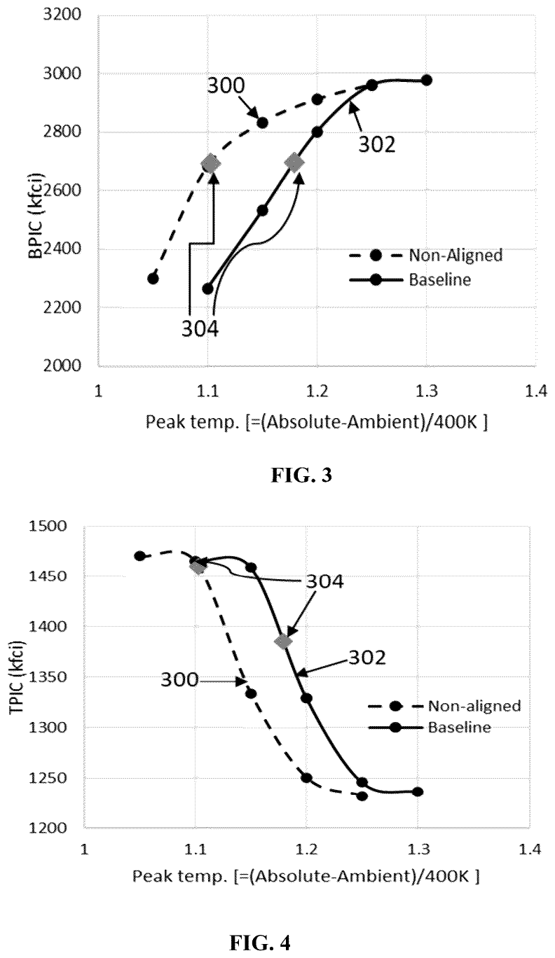

FIGS. 3 and 4 show the data in Table 1 plotted showing BPIC and TPIC versus Peak Temperature. FIG. 3 shows the present implementation (non-aligned) dual layer media 300 provides higher BPIC at lower temperatures compared to the baseline single layer media 302. The operation at lower temperature allows for higher track density (FIG. 4). BPIC and TPIC corresponding to maximum ADC for each set of data is shown as points 304.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

What is claimed is:

1. A magnetic media comprising:
a first granular recording layer having a grain structure;
a second granular recording layer having a grain structure; and
a continuous break layer separating the first and second recording layers, wherein the grain structures of the first and second recording layers are not aligned.

2. The magnetic media according to claim 1, wherein the continuous break layer is a dielectric material.

3. The magnetic media according to claim 1, wherein the continuous break layer comprises MgO or Ru.

4. The magnetic media according to claim 1, wherein the first and second recording layers comprise FePt.

5. The magnetic media according to claim 1, wherein each of the granular recording layers has a Curie temperature, wherein the Curie temperatures of the first and second recording layers is substantially equal.

6. The magnetic media according to claim 1, wherein the first and second recording layers have a thickness that range from 1 to 30 nanometers.

7. The magnetic media according to claim 1, wherein the grain structures have a grain size of from 4 nm to 8 nm.

8. The magnetic media according to claim 4, further comprising a segregant.

9. The magnetic media according to claim 8, wherein the segregant is B2O3, WO3, MoO3, Zr,O2, ZnO, CuO, Cr2N, Si3N4, VN, AlN, NbN, TiN, BN, TaN, HfN, C or h-BN.

10. The magnetic media according to claim 1, further comprising a cap layer.

11. The magnetic media according to claim 10, wherein the Curie temperature of the cap layer is greater than the Cure temperature of the first and second granular recording layers.

12. The magnetic media according to claim 1, further comprising at least one additional granular recording layer and a continuous break layer separating the at least one additional layer from the first or second recording layers.

13. A data storage device comprising:
a housing;
one or more electronic components disposed within the housing; and
at least one magnetic recording disk comprising a magnetic media according to claim 1.
